(19) United States
(12) Patent Application Publication
(10) Pub. No.: US 2013/0239617 A1
(43) Pub. Date: Sep. 19, 2013

(54) METHODS OF FORMING A GLASS WIRING BOARD SUBSTRATE

(71) Applicant: Thierry Luc Alain Dannoux, Avon (FR)

(72) Inventor: Thierry Luc Alain Dannoux, Avon (FR)

(21) Appl. No.: 13/989,563

(22) PCT Filed: Nov. 29, 2011
(86) PCT No.: PCT/US11/62292

§ 371 Date: May 24, 2013

Related U.S. Application Data
(60) Provisional application No. 61/417,925, filed on Nov. 30, 2010.

(51) Int. Cl. C03B 23/26

(52) U.S. Cl. CPC C03B 23/26
USPC 65/31; 65/105; 65/62; 65/61

(57) ABSTRACT

Disclosed is a method or process for forming a glass wiring board substrate for integrated circuit wiring boards, including providing a first molding surface (20) positioned on a first mold (22) having truncated conical pins (24) protruding therefrom, the pins (24) having a diameter at the top end (26) thereof of 150 micrometers or less, and a minimum pitch (28) of 400 micrometers or less, providing a glass sheet (30) having first and second surfaces (32,34) on opposite major sides thereof, pressing the first surface (32) of the glass sheet against the molding surface (20), heating the glass sheet (30) and the first molding surface (20) together to a temperature sufficient to soften a glass of which the glass sheet (30) is comprised, such that the pattern of the first molding (20) surface is replicated in the first surface (32) of the glass sheet (30), thereby producing a formed glass sheet (30′) having an array of holes (40) therein, cooling the formed glass sheet (30′) and the molding surface (20) together to a temperature below the softening point of said glass, and separating the formed glass sheet (30) from the molding surface (20). The forming may press the glass sheet using one mold surface or two mold surfaces simultaneously. For embodiments using a single mold, the holes may be blind holes after pressing, and may then be opened to form through-holes by back side lapping. Alternatively, the glass is pressed up to through-hole formation, avoiding the need of back side lapping.

This application claims the benefit of priority under 35 USC §119 to U.S. Provisional Application Ser. No. 61/417,925 filed Nov. 30, 2010 the content of which is relied upon and incorporated herein by reference in its entirety.

### FIELD

The present disclosure is related to package-integrated wiring board substrates particularly useful for CPU or GPU packaging, and particularly to methods for forming glass wiring board substrates.

### BACKGROUND AND SUMMARY

Newer generations of high-performance integrated circuits such as central processing units (CPUs) and graphics processing units (GPUs) are getting larger and are being designed to operate over wider operating temperature ranges than past generations. Larger sizes and larger operating temperature ranges cause a need for low coefficient of thermal expansion (low CTE) materials with CTE relatively close to silicon for use as wiring board substrates within the packaging of newer generation integrated circuits.

In typical packaging and mounting of a CPU, shown in diagrammatic cross section in FIG. 1, an integrated circuit formed on a silicon substrate 60 is mounted within a package that includes a heat spreader 62 in contact with the silicon substrate 60 via a thermal interface material 64. A wiring board 10 with multiple layers of wiring and insulator material built-up on it provides electrical connection between tight pitch (closely spaced) solder bumps 72 at an interface with the silicon substrate 60 and looser pitch (less closely spaced) solder bumps 74 that provide electrical connection between the integrated circuit in its package and cooperating interfaces, such as a mounting socket on a motherboard 80. The package and/or the motherboard may also include one or more capacitors 90.

As shown in the cross-section of FIG. 2, a wiring board substrate 10 provides the core structural layer upon which integrated circuit packaging wiring layers 102 and insulating layers 104 are built up, forming a built up layer structure 100. Through-holes 40 in the substrate 10 are plated or filled with conductive material to provide electrical connection between the wiring layers 102 on the two sides (major surfaces or flats) of the wiring board substrate 10.

Substrates in commercial use today are typically formed of fiber reinforced polymer, and the through-holes are produced by mechanical drilling. Polymer CTE is generally undesirably high relative to silicon, and mechanical drilling becomes difficult at smaller hole and pitch sizes.

Glass has previously been proposed for use as a wiring board substrate. Certain glasses can provide desirably low CTE. A remaining technical challenge is to provide a cost-effective process for drilling thousands of small holes, close together, while retaining structural strength of the substrate.

The present disclosure includes a method or process for forming a glass wiring board substrate for integrated circuit wiring boards, including providing a first molding surface positioned on a first mold having truncated conical pins protruding therefrom, the pins having a diameter at the top end thereof of 150 micrometers or less, and a minimum pitch of 400 micrometers or less, providing a glass sheet having first and second surfaces on opposite major sides thereof, pressing the first surface of the glass sheet against the molding surface, heating the glass sheet and the first molding surface together to a temperature sufficient to soften a glass of which the glass sheet is comprised, such that the pattern of the first molding surface is replicated in the first surface of the glass sheet, thereby producing a formed glass sheet having an array of holes therein, cooling the formed glass sheet and the molding surface together to a temperature below the softening point of said glass, and separating the formed glass sheet from the molding surface.

The glass material offers a low CTE well-matched to that of silicon. The forming process offers a dimensional reproducibility based on the use of non stick molds, desirably of graphite, the molds having a CTE close to the material to be formed. The forming process consists of pressing a glass sheet using one mold surface or two mold surfaces simultaneously, each mold surface presenting protrusions corresponding to the through-holes to be formed in the glass.

For embodiments of the method in which the through-holes are formed by pressing with a single mold, the holes may be blind holes after pressing, and may then be opened to form through-holes by back side lapping. Alternatively, the glass is pressed up to through-hole formation, avoiding the need of back side lapping. Other embodiments use two molds presenting forming protrusions, pressed on opposite major surfaces of the glass sheet to be formed.

The methods disclosed herein allow for low-cast mass production of many holes simultaneously, using a technology that displaces the formed material, rather than one that removes or adds material. This results in a more efficient and cost effective process. The use of graphite, the presently preferred mold material allows for very good reproducibility of hole position and spacing, due to good match of mold- and material-CTE over the range of molding temperatures.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a diagrammatic cross-section of a wiring board substrate 10 within an integrated circuit package;

FIG. 2 is a diagrammatic cross-section of a wiring board substrate 10 with built-up layers 100 thereon;

FIGS. 3-6 are diagrammatic cross-sections of a glass sheet 30 or formed glass sheet 30′ according to various process steps of certain embodiments of the present disclosure;

FIGS. 7-9 are diagrammatic cross-sections of a glass sheet 30 or formed glass sheet 30′ according to various process steps of certain other embodiments of the present disclosure; and

FIG. 10 is a digital image of a portion of an integrated circuit wiring board substrate produced according one or more of the methods disclosed herein.

### DETAILED DESCRIPTION

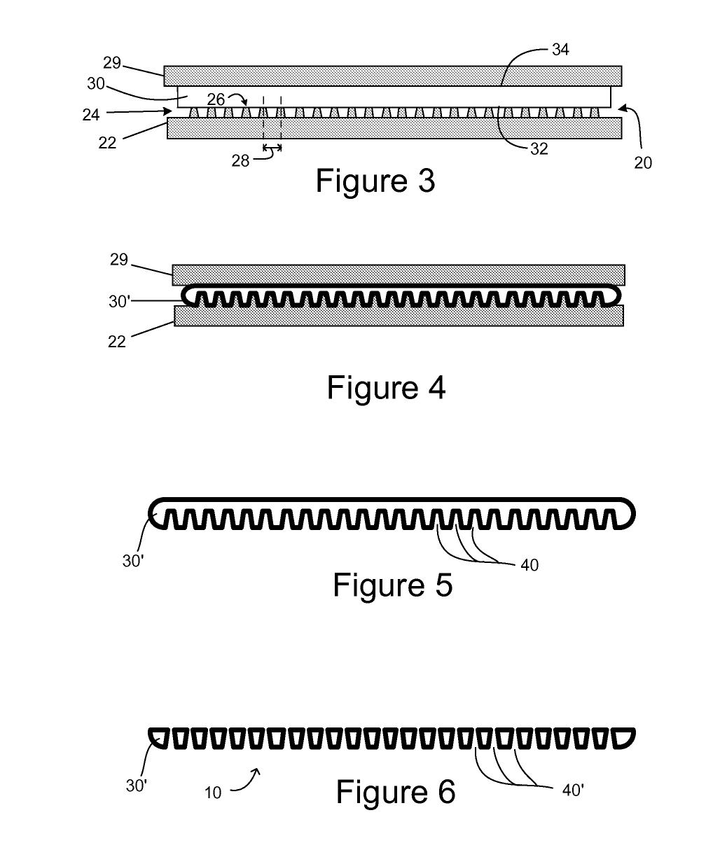

With general reference to FIGS. 3-6, according to an embodiment of a method of the present disclosure, a glass wiring board substrate 10 for use in integrated circuit packaging is produced by a method including providing a first molding surface 20 positioned on a first mold 22, having truncated conical pins 24 protruding therefrom, as shown in the diagrammatic cross-section of FIG. 3. The pins 24 desirably have a diameter at the top end 26 thereof of 150 micrometers or less, and a minimum pitch 28 of 400 micrometers or less.

The method further includes providing a glass sheet 30 having first and second surfaces 32 and 34, respectively, on opposite major sides thereof, and pressing the first surface 32 of the glass sheet 30 against the molding surface 20 of the mold 22. The pressing may be performed in part by pressure applied by an active or adjustable means, or by a weight, in either case, desirably applied through a refractory body 29 compatible with the material of the glass sheet 30, and more desirably of the same material as the first mold 22. The glass sheet 30 and the first molding surface 20 are then heated together to a temperature sufficient to soften a glass of which the glass sheet 30 is comprised, such that the pattern of the first molding 20 surface is replicated in the first surface 32 of the glass sheet 30, thereby producing a formed glass sheet 30′ having an array of holes 40 therein, as illustrated in the cross-sections of FIGS. 4 and 5. The formed glass sheet 30′ is then cooled together with the molding surface 20 to a temperature below the softening point of the previously softened glass, after which the formed glass sheet 30 and the molding surface 20 are separated from each other.

With proper selection of the material of the mold 22 and molding surface 20, the separation of the molding surface 20 from the formed glass sheet 30′ can be easily performed without any large forces and with little or no damage to the molding surface 20, allowing many uses of a given mold 22. This may preferably be achieved by selecting the material of the glass sheet 30 and the material of the mold 22 such that a CTE mismatch between the glass sheet 30 and the first molding surface 20 or the mold 22 is within the range of 0 to less than 15×10−7 at 300° C., and desirably over the entire temperature range from room temperature to above the softening point of the glass of the glass sheet 30. This also allows for sufficiently accurate hole positioning for wiring board substrate design specifications. Typically −/+20 μm variation in hole position or less can be relatively easily achieved over a 20 mm distance in the final product.

The first mold 22 and the first molding surface 20 formed are desirably formed from carbon by machining a carbon block using diamond-coated tools so as to form the first molding surface 20. This mold material releases well from the formed glass sheet 30′.

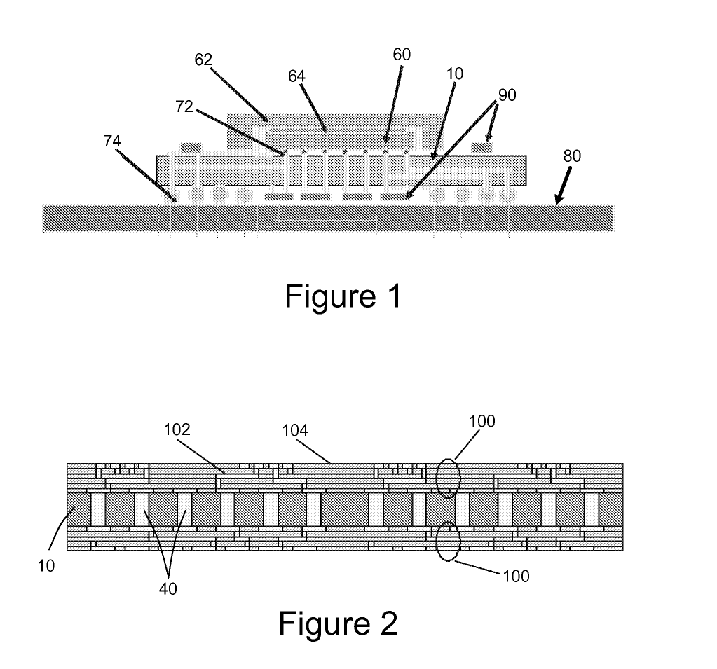

In the particular embodiment shown in FIGS. 4 and 5, the array of holes 40 resulting from the pressing and heating of the glass sheet 30 is an array of blind holes. In this case, an additional step may include one or both of grinding and polishing the formed glass sheet 30′, on the second surface 34 thereof, to sufficient depth to open the array of holes 40, resulting in an array of through-holes 40′ in the formed glass sheet 30 as shown in FIG. 6. According to an alternative embodiment, the pressing process may continue for sufficient time, and with sufficient pressure, such that the originally produced array of holes 40 after the pressing and heating process, is already an array of through holes 40′ as in FIG. 6. In either case, the resulting formed glass sheet 30′ with an array of through holes 40′ forms a glass wiring board substrate 10 useful in integrated circuit packaging as explained above with reference to FIGS. 1 and 2.

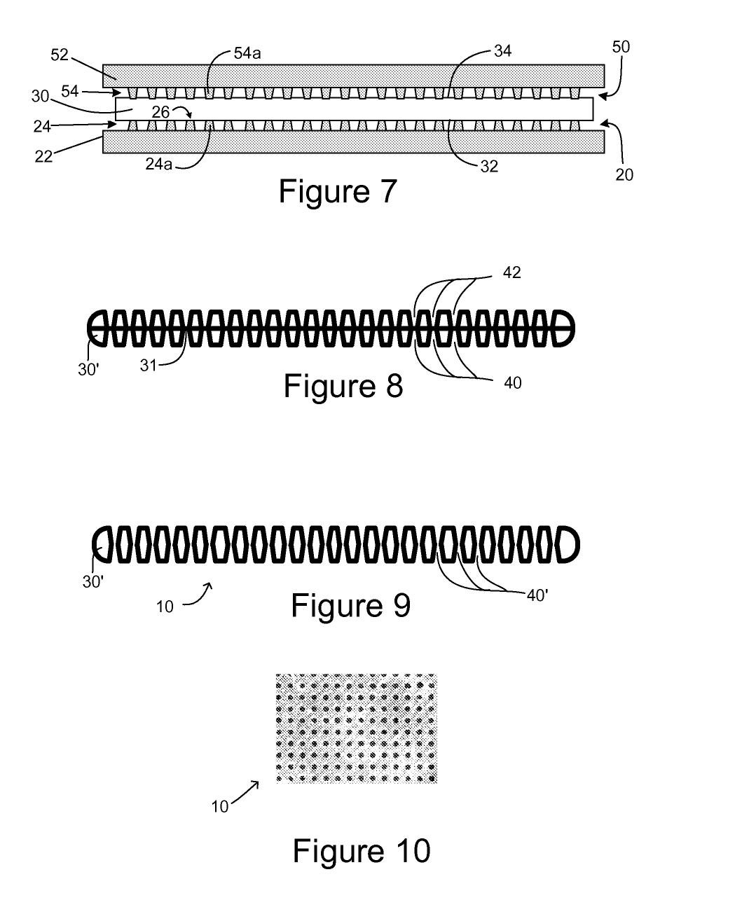

According to another alternative embodiment, illustrated generally by the cross-sections shown in FIGS. 7-9, a second molding surface 50 may be provided, positioned on a second mold 52, and the second surface 34 of the glass sheet 30 may be pressed against the second molding surface 50. The step of heating the glass sheet 30 and the first molding surface 20 together may then further comprise heating the second molding surface 50 also, at the same time, so that both molding surfaces 20, 50 and the glass sheet 30 are raised to a temperature sufficient to soften a glass of which the glass sheet 30 is comprised, and such that the pattern of the first molding surface 20 is replicated in the first surface 32 of the glass sheet 30, and the pattern of the second molding surface 50 is replicated, more or less simultaneously, in the second surface 34 of the glass sheet 30.

Desirably, the second molding surface 50 includes a first pin 54a thereon which is positioned in a mirror image location relative to a corresponding pin 24a on the first molding surface 20, as shown in FIG. 7. In an embodiment further represented by the cross section of FIG. 8, the resulting formed glass sheet 30′ includes two arrays of blind holes 40 and 42, on the first a second surfaces 32, 34, respectively. The holes formed by corresponding pins 54a and 24a are divided by a thin layer or web of glass 31, so the method desirably further includes etching the formed glass sheet 30′ sufficiently to join a hole formed in the second side 34 of the formed glass sheet 30′ by the first pin 54a with a hole formed in the first side 32 of the formed glass sheet 30′ by the corresponding pin 24a. This provides one or more open through holes. Desirably, an entire array of open through holes is produced, by using a second molding surface 50 that comprises multiple pins 54 arranged in a second-molding-surface pattern that is a mirror image of a first-molding-surface pattern of pins 24 on the first molding surface (20), with the resulting formed glass sheet with through-hole array 40′ as shown in FIG. 9. According to yet another alternative embodiment, the pressing process with two molding surfaces 20, 50 may continue for sufficient time, and with sufficient pressure, such that the originally produced arrays of holes 40, 42, after the pressing and heating process, is already an array of through holes 40′ as in FIG. 9. Regardless of the particular embodiment, the resulting formed glass sheet 30′ with an array of through holes 40′ again forms a glass wiring board substrate 10 useful in integrated circuit packaging as explained above with reference to FIGS. 1 and 2.

The glass of the glass sheet 30 desirably has a CTE in the range of 30 to 90×10⁻⁷/° C., more desirably in the range of 30 to 40×10⁻⁷/° C., so as to be relatively close to that of silicon.

### EXAMPLES

For Corning Code 0211 glass (available from Corning Incorporated of Corning, N.Y., USA and/or their distributors) a desirable graphite material may be EDM4 (available from Poco Graphite, Inc., Decatur, Tex., USA or their distributors) having a CTE of 78×10⁻⁷/° C. Mold surfaces comprising EDM4 were used to press Corning Code 0211 glass at 740° C. in a nitrogen atmosphere.

For actual production molds, diamond-tool machining is the preferred method for their formation. For the testing reported here, an EDM4 graphite mold was machined by wire EDM to produce 10 000 pins on 40×40 mm molding surface, the pins having a mean pitch 400 μm, a mean height of 230 μm, and a diameter at the bottom of the pins of 250 μm and 150 μm at the top. This mold was then used to press a sheet of Corning Code 0211 glass at 740° C. in a nitrogen atmosphere.

For back polishing, the molded glass was secured on a polishing support with adhesive wax melted at 70° C., then ground and polished to the level of the holes. For a 230 μm pin height, a 210 μm final thickness was targeted. A digital image of the resulting substrate 10 with array of holes is shown in FIG. 10.

As a second example, for Corning Eagle XG® glass (available from Corning Incorporated, Corning N.Y., USA, and/or their distributors), a desirable graphite material may be Ref 2020 (available from MERSEN [formerly Carbone Loraine] of Paris, France and/or their distributors), having a CTE of 38×10⁻⁷/° C. CTE. Mold surfaces comprising Ref 2020 were successfully used to press sheets of Eagle XG® glass at 1040° C., also in a nitrogen atmosphere.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A method of fabricating a glass wiring board substrate (10) for use in integrated circuit packaging, the method comprising:
providing a first molding surface (20) positioned on a first mold (22) having truncated conical pins (24) protruding therefrom, the pins (24) having a diameter at the top end (26) thereof of 150 micrometers or less, and a minimum pitch (28) of 400 micrometers or less,
providing a glass sheet (30) having first and second surfaces (32,34) on opposite major sides thereof;
pressing the first surface (32) of the glass sheet against the molding surface (20);
heating the glass sheet (30) and the first molding surface (20) together to a temperature sufficient to soften a glass of which the glass sheet (30) is comprised, such that the pattern of the first molding (20) surface is replicated in the first surface (32) of the glass sheet (30), thereby producing a formed glass sheet (30′) having an array of holes (40) therein;
cooling the formed glass sheet (30′) and the molding surface (20) together to a temperature below the softening point of said glass; and
separating the formed glass sheet (30) from the molding surface (20).

2. The method according to claim 1 wherein the step of providing a first molding surface (20) positioned on a first mold (22) comprises providing a first molding surface (20) and a first mold (22) formed from carbon.

3. The method according to claim 2 wherein providing a first molding surface (20) and a first mold (22) formed from carbon further comprises machining a carbon block using diamond-coated tools so as to form the first molding surface (20).

4. The method according to claim 1 wherein the glass sheet (30) has a CTE in the range of 30 to 90×10⁻⁷/° C.

5. The method according to claim 1 wherein the glass sheet (30) has a CTE in the range of 30 to 40×10⁻⁷/° C.

6. The method according to claim 1 wherein a CTE mismatch between the glass sheet (30) and the first molding surface (20) is within the range of greater than 0 to less than 15×10⁻⁷.

7. The method according to claim 1 further comprising one or both of grinding and polishing the formed glass sheet (30′), on the second surface (34) thereof, to sufficient depth to open the array of holes (40), resulting in an array of through-holes (40′) in the formed glass sheet.

8. The method according to claim 1 further comprising
providing a second molding surface (50) positioned on a second mold (52), and
pressing the second surface (34) of the glass sheet (30) against the second molding surface (50),
wherein the step of heating the glass sheet (30) and the first molding surface (20) together further comprises heating the second molding surface (50) together with the glass sheet (30) and the first molding surface (20), to a temperature sufficient to soften a glass of which the glass sheet (20) is comprised, such that the pattern of the first molding surface (20) is replicated in the first surface (32) of the glass sheet (30) and the pattern of the second molding surface (50) is replicated in the second surface (34) of the glass sheet (30).

9. The method according to claim 8, wherein the second molding surface (50) includes a first pin (54a) thereon positioned in a mirror image location relative to a corresponding pin (24a) on the first molding surface (20), and wherein the method further comprises etching the formed glass (30′) sheet sufficiently to join a hole formed in the second side (34) of the formed glass sheet (30′) by the first pin (54a) with a hole formed in the first side (32) of the formed glass sheet (30′) by the corresponding pin (24a).

10. The method according to claim 8, wherein the second molding surface (50) comprises multiple pins (54) arranged in a second-molding-surface pattern that is a mirror image of a first-molding-surface pattern of pins (24) on the first molding surface.
